(19) United States
(12) Patent Application Publication
(10) Pub. No.: US 2005/0035618 A1
(43) Pub. Date: Feb. 17, 2005

(54) Center floor console

(76) Inventors: Eric S. Toth, Holland, MI (US); Jon T. Moroney, Grand Haven, MI (US); Peter T. Laduke, Holland, MI (US); Kevin J. Fellows, Holland, MI (US); Michael A. Johnson, West Olive, MI (US); Joe Rankin, Grand Haven, MI (US); Brett W. Kooistra, Grand Haven, MI (US); Bruce A. Fredricks, Grand Haven, MI (US); Maurice R. Fredricks, Grand Haven, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/662,150

(22) Filed: Sep. 12, 2003

Related U.S. Application Data
(60) Provisional application No. 60/410,416, filed on Sep. 13, 2002.

(51) Int. Cl. B60R 7/04

(52) U.S. Cl. 296/24.34

(57) ABSTRACT

A storage console, comprising mix and match storage modules adapted to be arranged in a variety of positions on a supporting framework. The modules include end or terminal bins, lateral bins, medial bins, wall panels, and cargo nets among others. The framework of the console includes a base tray supporting a plurality of upright members, each having grooves of predetermined cross-section enabling a user to fix the desired modules. Each module is adapted to provide flexibility and cooperate with different storage compartments. Wall panels may be attached to the framework to facilitate secure and private storage. In addition, provision can also be made for connecting different powered accessories such as lighting, audio, video, and the like. In addition the base of the center floor console along with said accessories may with the twist of a latch, be removed from the vehicle entirely.

### REFERENCE TO RELATED APPLICATION

This application claims priority from U.S. Provisional Patent Application Ser. No. 60/410,416, filed Sep. 13, 2002.

### BACKGROUND OF THE INVENTION

1. Field of the Invention

The present invention generally relates to equipment and accessories for vehicles and particularly to a center floor console for vehicles.

2. Brief Description of the Related Art

There exists a need for adequate and dedicated floor console storage space in a vehicle. Many vehicles come equipped with a center floor console that appears to yield adequate storage room. However, these consoles fail to properly organize miscellaneous items stored in a vehicle.

Prior devices included an entirely enclosed floor console unit that served the purpose of general storage. Typically, however, this amounts to nothing more than a certain volume of space set aside within the cavity of a console for the general storage of all manner of items. It is difficult or impossible for the occupants of a vehicle to store miscellaneous items such as umbrellas, magazines, books, purses, and even trash, in a general storage cavity and keep it from becoming further disorganized. Naturally, occupants choose to place many personal items on the back seat, the floor, or in some other area of the vehicle, making the retrieval of personal items rather difficult and inconvenient.

Open-tray concepts have also been provided in the past. These types of storage units provide storage in small, often shallow, compartments with easy accessibility. However, the open tray concept does not provide the protective benefits of an enclosure. In addition this type of unit does not provide storage for larger objects such as umbrellas, magazines, or purses. In order to serve many different purposes, storage consoles having the ability to customize the different storage parameters is deemed necessary.

### SUMMARY OF THE INVENTION

According to one form of the invention, a storage console for a vehicle is provided comprising a base tray assembly, at least a first and a second upright support assembly spaced from each other and attached to the base tray assembly; and one or more storage modules detachably mounted to the first and second upright support assemblies for providing a storage solution as well as a substrate for mounting additional accessories. Variations and/or modifications to the invention include one or more connectivity sockets to one of the base tray assembly or the storage module which are adapted to be operably coupled to a comparable system within the vehicle. For example, one or more electrical sockets can provide access to power in the storage console. Another modification or aspect of the invention is the ability to expand and mix and match storage modules. This may be accomplished by additional structural members on one of the storage module or the upright support assemblies for attaching an additional storage module thereto. A plurality of wall members is also contemplated to be used to be detachably coupled to the upright support members and define a divider or confines of a compartment.

The range of storage modules is endless. For example, but without limitation, the storage modules may be selected from the group comprising a cup holder having at least one cup recess, a tray having an upright perimeter wall, a closable compartment including one of a hinged and sliding door, a coin module having at least one recess adapted to receive coins, a sunglasses storage module, a garage door opener module, a map module, a glove compartment, a tool compartment, a cooler, a refrigerator, an oven or warmer, a file tray, and a lid assembly for covering substantially the entire top area of the storage container. To provide this flexibility, the storage modules include universal fasteners for attaching to mating fasteners on the upright support assemblies and with adjacent storage modules.

In another form of the invention, a kit is provided for creating a custom storage console for a vehicle. The kit comprises a base tray assembly forming the foundation of the assembly to retain containers of predetermined dimension and for supporting additional structure. The kit further includes a framework or superstructure assembly adapted to be coupled to the base tray assembly upon which the different storage solutions can be positioned. The kit further includes a plurality of storage modules, many having different or functionally specific configurations and adapted to be mounted to one of the superstructure or another storage module. The kit may also include optional features or accessories such as a power cord having a socket at one end and a plug at an opposite end; the socket end adapted to be received within a predetermined one of the storage modules to receive an accessory where the plug end is adapted to be operably coupled to a compatible system of the vehicle. The kit further includes an anchoring member for fixing the base tray assembly at a predetermined position within the vehicle. The anchoring member prevents the assembly from sliding or moving while the vehicle is in motion.

Another form of the invention contemplates a center floor console having a bottom tray, frame assembly attached to the bottom tray, and at least one storage module mounted to said frame assembly. The storage console further comprises an outlet mounted to the bottom tray and/or one of the storage modules. The outlet, such as a power socket, is adapted to be operably coupled to an appropriate system of the vehicle and providing easy access to that system within the vehicle. A plurality of wall members may also form a part of the kit so the user can create detachable walls about the frame assembly. An anchoring system is also part of the invention to fix the bottom tray in position relative to the vehicle.

In another form of the invention, one or more of the components comprising the invention may be used in combination or alone. For example, the bottom tray may include a floor and a rail of predetermined height and length extending from the floor to define an area for receiving articles. The frame assembly may include as few as one preassembled structure, or multiple components assembled by the user to provide at least a first and a second upright support assembly. The support assembly may have a plurality of legs, each having a first end attached to said bottom tray and a second end adapted to receive one of the storage modules. The storage modules may include component pieces such as a cup holder, a tray, a coin receptacle, an eye glass storage compartment, a garage door opener storage compartment, cell phone storage compartment, a map storage compartment, a glove compartment, a tool compartment, a food and beverage cooler, a food and beverage warmer, a file box, an audio media storage compartment, a video media storage compartment, an audio-visual media player compartment, a compartment for receiving a part of a vehicle heating and cooling system, and a general storage compartment. Some or all of the storage modules may include a mechanism for providing an attachment to one of said frame assembly or to a second storage module.

In yet another form of the invention, a center floor console assembly is provided for a motor vehicle comprising a bottom tray, a plurality of upright supports, each having one end attached to the bottom tray and a second end spaced from said bottom tray; a cross bar interconnecting the second end of two of the plurality of upright support members, a first storage module attached to the second end of a first plurality of upright supports, a second storage module attached to the second end of the second plurality of upright supports, and at least one socket operably coupled to a power supply within the vehicle and mounted on the center floor console. Additional storage modules may be provided intermediate and substantially adjacent the first and second storage modules. The additional storage modules may include a file hanger assembly intermediate and substantially adjacent the first and the second storage modules. Additional storage module may repose on the bottom tray or be retained by a member detachably coupled to a rail extending along opposing sides of the bottom tray. Each bottom tray may further include an anchoring member attached to the bottom tray for preventing the center floor console from sliding within the vehicle while the vehicle is in motion. As in the previous embodiments or forms of the invention, upright supports, the storage modules, and the cross member may be disassembled and broken down into smaller components for easy storage.

The advantages provided by this invention include the ability of the user to customize the arrangement of storage space within a structure located within close proximity to the vehicle occupants. By permitting the user to customize storage space, space utilization is maximized and at the very least, the user has a much better ability to find items than using the prior large cavity consoles of the prior art. These and other advantages will become readily apparent to the reader by referring to the following drawing figures in cooperation with the description of the invention.

### BRIEF DESCRIPTION OF THE DRAWING FIGURES

FIG. 1 is a schematic cartoon view of one embodiment of the center floor console assembly invention deployed within a vehicle;

FIG. 2 is an oblique view of one embodiment of the center floor console assembly forming the invention;

FIG. 3 is a side elevation of the invention shown in FIG. 2;

FIG. 4 is an plan view of the invention shown in FIG. 2;

FIG. 5 is an end elevation of the invention shown in FIG. 2;

FIG. 6 is a fragmentary cross-section view of one of the upright supports forming the framework or superstructure of the invention;

FIG. 7 illustrates another embodiment of a center floor console assembly embodying the instant invention.

### DETAILED DESCRIPTION OF THE VARIOUS EMBODIMENTS

There is a need in the today's vehicles for an innovative storage center that is designed in such a manner as to allow the vehicle's user to customize the storage space. The ability to customize should include easy modification of external and internal features according to his or her taste, vehicle use, or driving environment. The present invention accomplishes this goal by providing a multi-configuration storage console.

The storage console includes a foundation and framework for attaching a variety of accessories for the benefit of the user. This is accomplished by designing grooves, slots, or notches of appropriate depth and shape in legs and framework of the console which enables a user to snap, catch, slide, or otherwise engage appropriate bins, nets, and panels necessary for the intended use of the console.

The aforementioned accessories include, but are not limited to, front and rear storage bins, side storage bins and privacy panels, internal storage bins, and accessory nets. The storage bins are designed specifically for the storage of dedicated items such as magazines, notebooks, umbrellas, personal digital assistants (“PDAs”), and cell phones among other items, and for the storage of general items such as purses, keys, compact discs (“CDs”), trash, and other items. A bar on either side of the console, near the base, is provided for the attachment of additional storage bins.

One embodiment of this center floor console provides locking privacy panels that snap, slide or otherwise engage onto the external frame and legs of the console, enabling a user to have secure and private storage for his or her belongings.

Another embodiment of this invention entails having a low-intensity lighting system placed in the base of the center floor console such that light from the unit will illuminate the center floor console's contents.

In some embodiments of this invention, the main structure of this center floor console can, with a twist of a latch or other fastener, be removed from the vehicle. A base panel with a console-nesting feature remains attached to the floor for the convenient re-attachment of the console at a later time. Removing the console enables an occupant to pass through to the second or third row of seating with ease. As suggested above, a premise of the invention is to provide the user the ability to customize the particular storage options to fit his or her particular storage needs. In order to provide such flexibility in the storage console while simultaneously controlling tooling options from the manufacturing side, the invention utilizes components designed to be mixed and/or matched with the maximum amount of structural integrity while maintaining stylistic considerations. The following description will make reference at times to very specific module designs and/or configurations. However, it should be understood that these specific module designs and configurations and combinations are not intended to be construed as limitations. Clearly the purpose of this description is to provide the reader with an understanding of the structural interactivity and relationship between the components, and not to limit the scope of the invention.

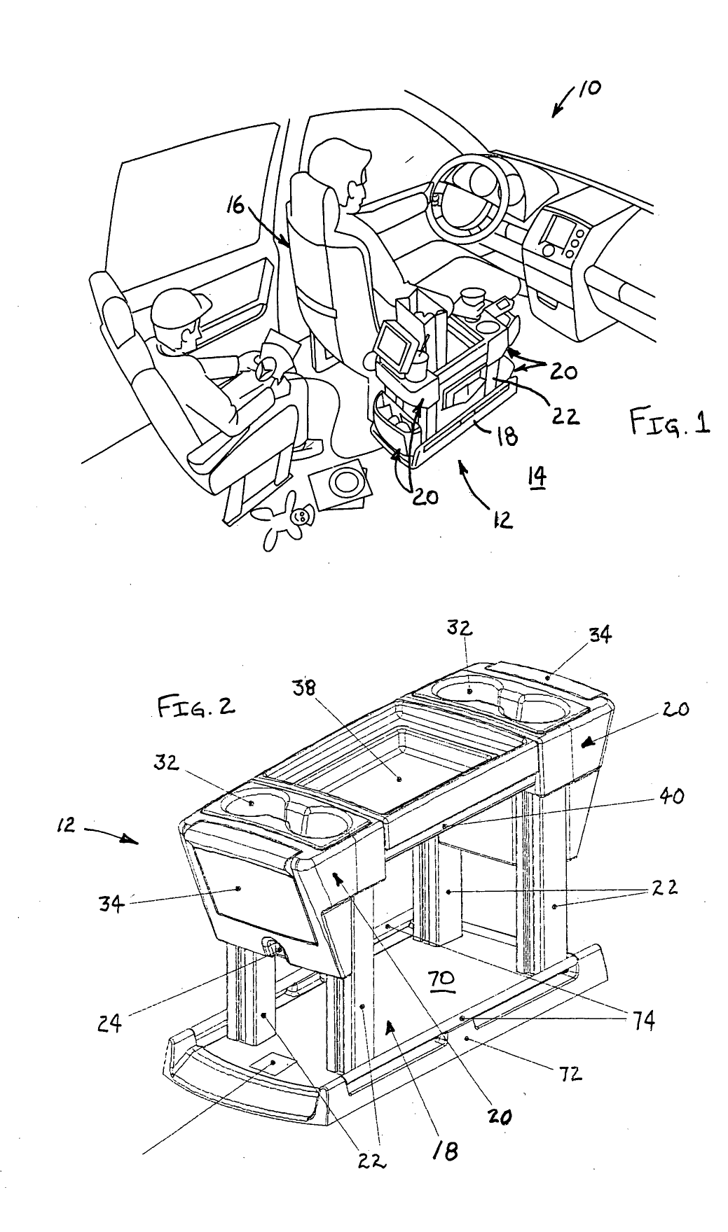

FIG. 1 generally illustrates a partial view of an interior of a vehicle 10. More specifically, the figure illustrates in partial view the interior of an automobile 10 such as a minivan, sport utility vehicle, truck or other vehicle utilizing one embodiment of the inventive console assembly 12. As is often the case, the console assembly 12 is designed to be disposed on the floor 14 of the vehicle, typically adjacent one of the several seats 16, to provide storage for a variety of items at a central location that is easily accessible within the vehicle 10. However, such a console may be located at another location in the vehicle such as suspended from the ceiling or roof of the vehicle with minor modification to the orientation of some of the structure. In the particular instance illustrated, the storage console 12 includes a base tray assembly 18 resting on the floor 14 of the vehicle and containing a number of storage modules 20 for retaining articles. Certain of these modules 20 are intended to be located on the base tray 18, while others are supported above the base tray 18. The upper modules 20 are supported by at least a first and a second upright support member 22 extending from the base tray assembly 18. Each upright support member 22 is spaced from the other and attached to the base tray assembly 18 to provide the framework to support the additional storage modules above the base or bottom tray assembly 18. Because the needs of users are different, the instant invention is designed to take that need into account. The storage console 12 is provided with a number of storage modules of different shape, form, and size to be detachably mounted to the framework as well as each other to provide the desired storage solution.

The storage console 12 of this invention also anticipates there may be need by the user to store devices on the console 12 that require electrical power or other connectivity. To meet this need, the console is designed to include at least one outlet or socket 24 and preferably a plurality of application specific outlets to provide the connection of multiple devices. For example, it is anticipated such devices may include cell phone power adaptors, dc-to-ac power converters, and audio-visual connections such as headsets and entertainment, centers such as video games and video or compact disc players, as well as the associated display panels. In today's age, the demands for connectivity within the vehicle are expanding. So in order to anticipate such demands, a range of socket options will be attached in one form or another to one of the base tray assembly 18 and one or more of the storage modules 20 and operably coupled to a correspondingly appropriate system within the vehicle.

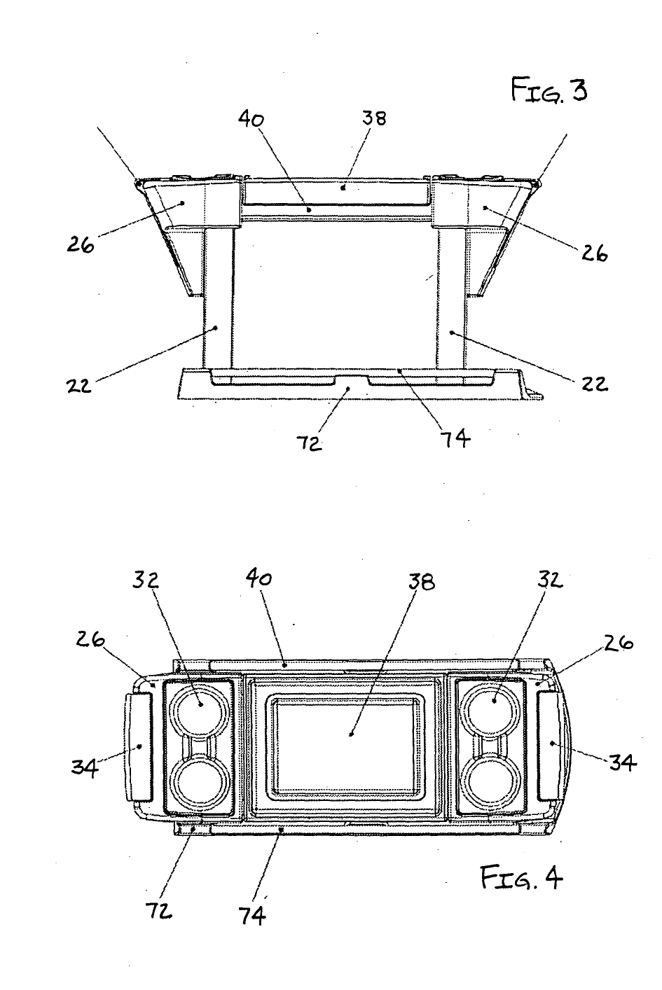

The embodiment of the invention shown in FIGS. 2 through 5 contemplates the placement of similar storage modules such as designated by reference numeral 26 at opposite ends of the console 12. The storage modules 26 disposed at the ends of the console above the bottom tray 18 are referred to as “Terminals” as they form the terminal ends of the console. Such Terminals 26 share that common characteristic as well as providing various additional structural aspects to the interior of the console, depending upon the desired function. These different aspects will be described below. Modules intended to be disposed between the Terminal modules will be referred to generally as “Medial” modules. As the name implies, Medial modules form the central or interior region of the console.

In the particular embodiment illustrated in FIGS. 2-5, it is contemplated four upright support members 22 extend upwardly from the base or bottom tray 18, with each of the upright supports 22 forming a corner of a rectangle. In a preferred embodiment, each upright support 22 may be formed from a variety of materials and molded or extruded into a generally polygonal tube to provide structural rigidity. More specifically, the preferred embodiment also contemplates the extrusion may include at least one longitudinal channel 28 along the support 22. Ultimately, it may be found desirable to include such a channel 28 in each of the faces of the extrusion 22 to provide greater flexibility and universal application. The shape of the channel at the time of this writing may take on any form, but one such shape may include an inverted “V” to permit fasteners to slide within the channel 28, but not be pulled out. Certainly other configurations may be designed by those skilled in the art and depending in large part upon the desired application.

Each of the Terminals 26 may include a molded housing 30 of predetermined form and having at least one recess (not shown) of a shape adapted to receive the upper ends of the upright supports 22. The recess or socket for the upper end of the support 22 may be of a dimension to easily receive the support 22 requiring a fastener to keep the two components engaged, or of a closer tolerance so that a press-fit is adequate to fix to the upright 22. As more specifically shown in FIGS. 2-5, one embodiment of Terminals 26 include one or more upper recess 32 for retaining drinks as well as an interior storage compartment (not shown) formed by that portion of the housing 30 depending below and offset from that portion containing the drink recesses 32. A door 34 is illustrated to open and close the access opening to the interior storage compartment. The applications for such a compartment are plentiful and could include an ash tray with enclosed cigarette lighter, and storage for eye glasses, sunglasses, garage door opener remotes, coin, gloves, tissues and the like. The possible uses for such spaces are endless and cannot be fully anticipated at the time of this writing. The reader should also note in the embodiment shown in these figures the anticipated location for one of the sockets briefly mentioned above. As best illustrated in FIGS. 2 and 5, one such socket 24 may be provided at the lower edge 36 of Terminal module 26 making it generally accessible from the end of the console 12.

Also shown in FIG. 2-5 is a low profile Medial storage module 38 in the form of a tray intermediate Terminals 26. The tray 38 provides a generally wide, long and shallow area for storing items. Such may be used to receive small bags or boxes, papers, and other miscellaneous items selected by the user. Tray 38 may be supported by horizontal supports or beams 40 extending between each of the Terminals 26. For example, each beam or support 40 may be formed from a tubular material of sufficient strength and rigidity to bridge the distance between the Terminals 26. The ends of the beams 40 may be held in position by recesses formed in the interior facing surfaces of the Terminals 26. Alternatively, the beams 40 may be attached to the upper ends of the upright support members 22 to form a framework or superstructure above the bottom tray 18. In the latter configuration, accommodation would need to be made in the interior facing wall of the Terminals 26 to receive the beams 40 proximate the upright supports. The low profile tray 38 is anticipated to include channels or the like along the underside of the perimeter edge 42 of sufficient dimension to be press fit over the beams or horizontal supports 40 to fix the tray in position. Alternatively, snap fit fasteners may be molded into the underside of the tray to accomplish the same purpose. It is also anticipated that no fastening mechanism at all be provided to engage the beams 40, but rather mating fasteners (not shown) may be designed in the ends 44 of the tray 38 adjacent Terminals 26 to engage corresponding mating fasteners and fix it in place. Lastly it is anticipated that a combination of the aforementioned fastening systems may be provided to insure a secure and rugged assembly.

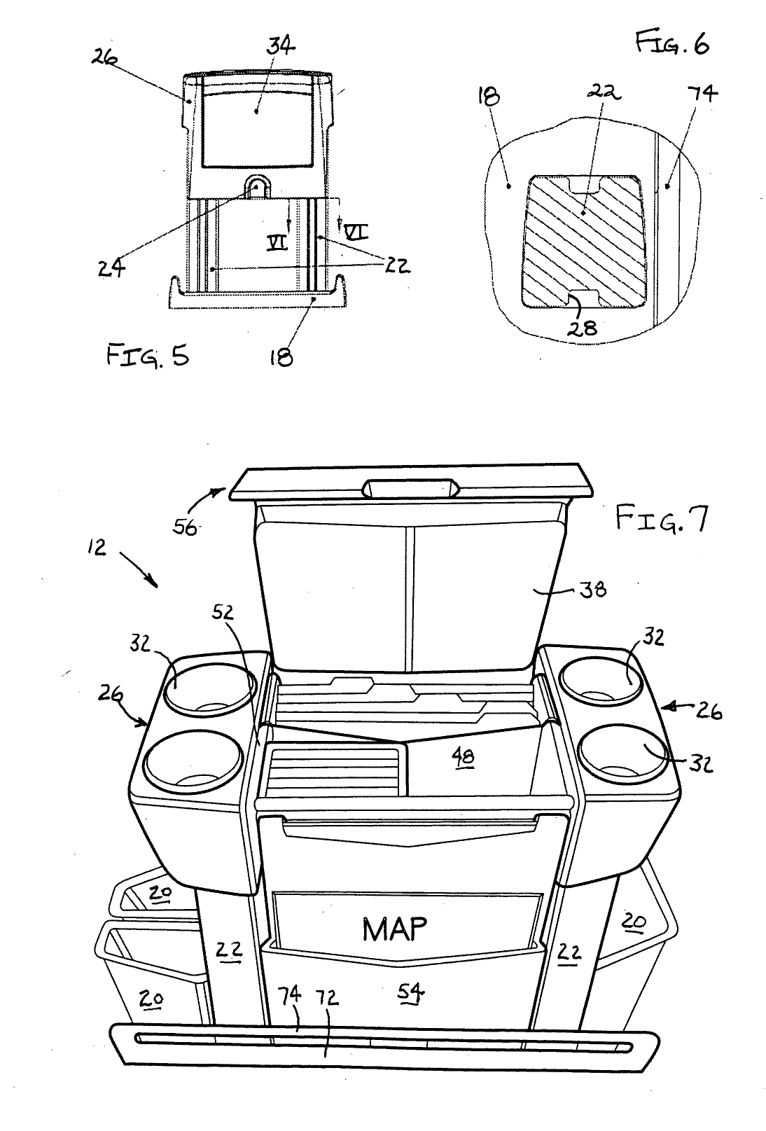

Alternate Medial modules to tray 38 may have a variety of configurations. For example it is contemplated that tray 38 may be replaced by a bin of substantial depth to serve as a file container or deep storage bin. One example of such an embodiment is illustrated in FIG. 6. In this particular embodiment, the bottom tray 18, upright supports 22 and Terminals 26 may be substantially identical to the previously described embodiment. A plurality of wall members or panels 46 may be designed such that each may be detachably coupled to two support members 22 and perhaps bottom tray 18 and beam 40. Additionally, a similar panel 48 of same or different dimension may be positioned within the cavity defined by the wall members to serve as a divider or compartment interior wall or boundary. It is contemplated such wall panels 46 and 48 may have an edge received within a channel (not shown) defined in one edge of an extrusion 50 with the opposite edge of the extrusion 50 received within the proper channel 28 of a respective support 22. Without the extrusion or coupler 50, the panel 46 or 48 may be received within a close-tolerance channel defined in an interior facing wall of the Terminals 26 as well as a similar channel defined in the bottom tray 18. The walls of the Terminals 26 facing the Medial module area may be designed to provide file hanger channels or rims such as designated by numeral 52. Like modifications may include pockets bins 54 formed on the exterior surface of wall panels 46 to retain and store substantially flat items such as maps, vehicle registration materials and the like. Another modification or custom feature of the embodiment shown in FIG. 6 is the use of a lid or door 56 hinged along one side so as to close the upper end of the Medial bin. For example, it is also anticipated that tray 38 described above could be easily modified to be hinged and serve as a closure over the space defined by wall panels 46. In yet another alternative embodiment would be to hinge the tray 38 so it serves to close the bin as just mentioned and to hinge the door 56 to the upper surface of the tray 28 for closing the tray 38. As just illustrated, the variations to this invention can be substantial.

Another variation of a Medial module is like that of the file storage system described above, but modified slightly. Rather than having separate wall panels such as 46 and 48, the bin would be molded as a single piece in the form of a rectangular box open at one end. This type of structure could be inserted and withdrawn from the central region of the console as a unit for easy transport of the articles contained therein. Additionally, the rails for supporting any file hangers or the like could be integrally molded into the upper edge of the box to accommodate both letter and legal size hangers. A handle could be pivotally attached to the bin to provide easy transport. This type of insert could also serve the double function of a food and beverage cooler. Provision could be made to provide an insulating wall to increase the cooling capacity of the bin should it be desired. Other alternatives would include replacing the box or bin with an appliance that provides both refrigeration and heating of the cavity depending upon the need. Similar devices providing these combined functions are commercially available.

As briefly mentioned above, the storage console 12 of this invention is intended to be located on the floor of the vehicle. To prevent the console from sliding or shifting while the vehicle is moving, a mechanism attached to the base or bottom tray assembly 18 fixes the position or location of the storage console 12 relative to the vehicle 10. For example, one such mechanism may include one of a hook or loop-type fastener that engages the fibers of the vehicle floor treatment. Another option may include actual fasteners extending through the bottom tray into the vehicle substrate.

The base or bottom tray assembly 18 may come in a number of different embodiments. In the most general form, the bottom tray 18 is comprised of a floor 70 having anyone of a number of different textural surfaces intended to reduce the rolling and sliding of objects resting on its surface. In another embodiment, the general form of the tray 18 may include at least one barrier such as a wall 72 of predetermined height, depth and length relative to the floor 70 to define the extent of an area within the base 18 for receiving articles such as shown in FIG. 7. In one embodiment, it is contemplated such a wall 72 may extend around the entire perimeter of the bottom tray 18. Additional smaller areas may be defined by lower barriers or walls (not shown) depending upon the desire of the manufacturer. In the embodiment shown in FIG. 7, rails 74 provide an attachment point for a cargo net to constrain objects otherwise difficult to fix, such as round or cylindrical shapes Storage containers and bins of different dimensions and shapes may also conveniently be placed on the bottom tray 18.

In another form of the invention a center floor console for a vehicle is provided, comprising a bottom tray, a frame assembly attached to said bottom tray, and at least one storage module mounted to said frame assembly. The storage console may further comprise a connectivity outlet mounted to one of the bottom tray or one of the storage modules and that is operably coupled to a compatible system within the vehicle. The modules defining the console may be formed from a plurality of wall members detachably coupled to the frame assembly. The wall panels may also be arranged to divide one compartment into two compartments or divide the bottom tray into two areas. The storage console may also include a member attached to bottom tray for fixing the bottom tray in position relative to the vehicle. In turn, the bottom tray may include a floor and a rail of predetermined height and length extending from said floor to define an area for receiving articles. The frame assembly for the console may be comprised of at least a first and a second upright support assembly, each having a first end attached to said bottom tray and a second end adapted to receive said at least one storage module. The storage module includes at least one storage compartment. The storage compartments may provide for the receipt of any number of items including but not limited to drinks, coins, eye glasses, garage door openers, cell phones, map and other documents, gloves, tools, and files. The modules may also provide a receptacle for audio-visual media players, audio-video media, and an auxiliary heating and cooling system. The storage modules are attached to the storage console by a unique arrangement of cooperating fasteners, either with adjacent storage modules or with the associated framework.

The invention described above may come preassembled in accordance with a special order from the customer. However, another option is that the basic components and accessories will be sold as a kit. The components for the kit and its accessories may comprise a base tray assembly for providing a stand-alone framework for retaining containers of predetermined dimension and a base for supporting additional structure. A superstructure assembly, also referred to above as a framework and upright support assembly, may have a variety of configurations adapted to be coupled to said base tray assembly. The kit would include a plurality of basic storage modules such as at least one Terminal and one Medial, all of which are adapted to be mounted to one of the framework and another module. The kit may also include at least one connectivity cord for connecting with the vehicle and provide power to a socket. The socket is adapted to be received within one of the storage modules or the base tray. An anchoring member is also provided for fixing the base tray assembly at a predetermined position within the vehicle.

The superstructure or framework for the kit may have a plurality of upright support members, each adapted to have one end attached to said base tray assembly. In addition, at least one beam member and preferably two are provided for interconnecting an upper end of the upright support member to an upper end of another of upright support member.

In another embodiment, the center floor console assembly for a motor vehicle includes a bottom tray such a identified by numeral 18, a plurality of upright supports, each having one end attached to said bottom tray and a second end spaced from said bottom tray. A cross bar is provided to interconnect the second end of the upright support members to create a framework above the bottom tray. The framework receives at least one storage module and, in most instances, more than one storage module to suit the user's requirements. The floor console also includes at least one connectivity socket mounted to a predetermined location on one of the bottom tray or one of the storage modules. The connectivity socket in turn is adapted to be operably coupled to a corresponding system within the vehicle. In addition to the storage modules attached to the framework, the invention also contemplates additional removable modules for use on the bottom tray. These may include cans, boxes, trays, and the like of different sizes and with or without closing lids.

The bottom tray of this embodiment is likely to include a pair of rails, each extending along opposing sides of said bottom tray. The rail not only serves to retain objects on the bottom tray, but also as an attachment point for accessories such as cargo nets or other containers held to the bottom tray using a connector engaging the rail. Because it is anticipated substantial mass may be held by the bottom tray, an anchor is provided to secure the bottom tray to the vehicle to prevent the center floor console from sliding within the vehicle.

Another aspect of this invention briefly mentioned above is the ability to customize the specific configuration. The plurality of upright supports, cross members and the storage modules may be disassembled and separated from said bottom tray. The modules may be separated from the upright supports and cross member individually and rearranged, or the entire framework assembly with the storage modules attached may be removed as a unit, depending upon the user's need.

The above description is considered that of the preferred embodiments only. Modifications of the invention will occur to those skilled in the art and those who make or use the invention. Therefore, it is understood that the embodiments shown in the drawings and the examples set forth herein are described merely for illustrative purposes and not intended to limit the scope of the invention as interpreted according to the principles of patent law, including the doctrine of equivalents.

1. A storage console for a vehicle, comprising:
a base tray assembly;
at least a first and a second upright support assembly spaced from each other and attached to said base tray assembly; and
at least one of a plurality of predetermined-configuration storage modules detachably mounted to an upper end of one of said first and second upright support assemblies for providing a storage solution and a substrate for mounting additional storage modules to the storage console.

2. The storage console as defined in claim 1, further comprising a power outlet attached to one of said base tray assembly and said first storage module, and adapted to be operably coupled to a power system of the vehicle, for providing access to power in the storage console.

3. The storage console as defined in claim 1, further comprising a member on one of said at least one storage module and said first and second upright support assemblies for attaching a second one of a plurality of storage modules thereto.

4. The storage console as defined in claim 1, further comprising a plurality of wall members detachably coupled to said first and second upright support members for defining one of a divider and a compartment boundary.

5. The storage console as defined in claim 1, further comprising a mechanism attached to said base tray assembly for fixing a location of said base tray assembly relative to the vehicle.

6. The storage console as defined in claim 1, wherein said base tray assembly includes:
a floor; and
at least one wall of predetermined height and length extending from an upper surface of said floor for defining an area within said base for receiving articles.

7. The storage console as defined in claim 1, wherein each of said first and second upright support assemblies includes a first end attached to said base tray assembly and a second end adapted to receive one of said plurality of predetermined-configuration storage modules.

8. The storage console as defined in claim 1, wherein said plurality of predetermined-configuration storage modules is selected from the group comprising a cup holder having at least one cup recess, a tray having an upright perimeter wall, a closable compartment including one of a hinged and sliding door, a coin module having at least one recess adapted to receive coins, a sunglasses storage module, a garage door opener module, a map module, a cargo net, a glove compartment, a tool compartment, a cooler, a warmer, a file tray, and a lid assembly for covering substantially the entire top area of the storage container.

9. The storage console as defined in claim 1, wherein said plurality of predetermined-configuration storage modules includes fasteners for attaching to said first and second upright support assemblies, and to adjacent storage modules in snap-fit arrangement.

10. The storage console as defined in claim 1, wherein said plurality of predetermined-configuration storage modules are molded from a polymeric material.

11. A kit for creating a custom storage console for a vehicle, the kit comprising:
a base tray assembly for providing a stand alone framework for retaining containers of predetermined dimension and a base for supporting additional structure;
a superstructure assembly adapted to be coupled to said base tray assembly; and
a plurality of storage modules of different configurations, each of which is adapted to be mounted to one of said superstructure and another storage module in one of a plurality of configurations.

12. The kit as defined in claim 11, further including a power cord having a socket at one end and a plug at an opposite end, said socket end adapted to be received within a predetermined one of said plurality of storage modules to receive an accessory, and said plug end adapted to be operably coupled to an electrical system of the vehicle.

13. The kit as defined in claim 11, further including an anchoring member for fixing said base tray assembly at a predetermined position within the vehicle.

14. The kit as defined in claim 11, wherein said superstructure includes a plurality of upright support members, each adapted to have one end attached to said base tray assembly.

15. The kit as defined in claim 14, further including at least one beam interconnecting an upper end of one of said upright support members to an upper end of another of said upright support members.

16. A center floor console for a vehicle, comprising:
a bottom tray;
a frame assembly attached to said bottom tray; and
at least one storage module mounted to said frame assembly.

17. The storage console as defined in claim 16, further comprising a power outlet mounted to one of said bottom tray and said at least one storage module, and adapted to be operably coupled to a power system of the vehicle for providing power to the storage console.

18. The storage console as defined in claim 16, further comprising a plurality of wall members detachably coupled to said frame assembly to function as one of a divider and a compartment boundary.

19. The storage console as defined in claim 16, further comprising a member attached to said bottom tray for fixing said bottom tray in position relative to the vehicle.

20. The storage console as defined in claim 16, wherein said bottom tray includes:
a floor; and
a rail of predetermined height and length extending from said floor to define an area for receiving articles.

21. The storage console as defined in claim 16, wherein said frame assembly comprises at least a first and a second upright support assembly, each having a first end attached to said bottom tray and a second end adapted to receive said at least one storage module.

22. The storage console as defined in claim 16, wherein said at least one storage module includes at least one storage compartment.

23. The storage console as defined in claim 22, wherein said at least one storage compartment comprises one of a cup holder, a tray, a coin receptacle, an eye glass storage compartment, a garage door opener storage compartment, cell phone storage compartment, a map storage compartment, a glove compartment, a tool compartment, a food and beverage cooler, a food and beverage warmer, a file box, an audio media storage compartment, a video media storage compartment, an audio-visual media player compartment, a compartment for receiving a part of a vehicle heating and cooling system, and a general storage compartment.

24. The storage console as defined in claim 16, wherein said at least one storage module includes a mechanism for providing an attachment to one of said frame assembly or to a second storage module.

25. A center floor console assembly for a motor vehicle, comprising:
a bottom tray;
a plurality of upright supports, each having one end attached to said bottom tray and a second end spaced from said bottom tray;
a cross bar interconnecting said second end of two of said plurality of upright support members;
a first storage module attached to said second end of a first plurality of upright supports;
a second storage module attached to said second end of a second plurality of upright supports; and
at least one socket mounted on the center floor console and operably coupled to a power supply within the vehicle.

26. The center floor console as defined in claim 25, further including a third storage module intermediate and substantially adjacent said first and said second storage modules.

27. The center floor console as defined in claim 25, further including a file hanger assembly intermediate and substantially adjacent said first and said second storage modules.

28. The center floor console as defined in claim 25, further including at least one storage module configured to repose on said bottom tray.

29. The center floor console as defined in claim 25, further including a rail extending along opposing sides of said bottom tray.

30. The center floor console as defined in claim 25, further including a member attached to the bottom tray for preventing the center floor console from sliding within the vehicle

31. The center floor console as defined in claim 25, wherein said plurality of upright supports, said first and second storage modules, and said cross member may be disassembled and separated from said bottom tray.

32. The center floor console as defined in claim 25, wherein each of said plurality of upright supports includes an attachment mechanism for coupling with adjacent structures.

33. The center floor console as defined in claim 25, wherein said first storage module includes at least one storage compartment accessible through an opening.

34. The center floor console as defined in claim 25, wherein at least one of said first and said second storage module includes at least one cup holder.

35. The center floor console as defined in claim 33, wherein said at least one storage compartment includes a closable door for covering said access opening.

36. The center floor console as defined in claim 33, wherein said first and said second storage modules are of different shapes and storage configurations.
